(19) United States
(12) Patent Application Publication
(10) Pub. No.: US 2026/0259580 A1
(43) Pub. Date: Sep. 3, 2026

(54) WEARABLE ELECTRONIC DEVICE AND METHOD FOR CONTROLLING SAME

(71) Applicant: Samsung Electronics Co., Ltd., Suwon-si (KR)

(72) Inventors: Jinwoo CHAE, Suwon-si (KR); Sunyoung JI, Suwon-si (KR); Yoonji KIM, Suwon-si (KR); Yunhui CHO, Suwon-si (KR)

(21) Appl. No.: 19/655,069

(22) Filed: Apr. 22, 2026

Related U.S. Application Data
(63) Continuation of application No. PCT/KR2024/016262, filed on Oct. 24, 2024.

(30) Foreign Application Priority Data
Oct. 31, 2023 (KR) 10-2023-0147800
Jan. 2, 2024 (KR) 10-2024-0000530

(51) Int. Cl. G06F 1/16; H02S 20/30; H02S 40/38

(52) U.S. Cl. CPC G06F 1/163; G06F 1/1635; G06F 1/1698; H02S 20/30; H02S 40/38

(57) ABSTRACT

An electronic device is provided. The electronic device includes a first housing having a fastening part provided at a lower end thereof, a ring-shaped second housing having an accommodation part provided at an upper end thereof, the accommodation part configured to detachably accommodate the fastening part of the first housing to allow the first housing to move in response to a downward pressing input applied to the first housing, memory, including one or more storage media, storing instructions, and a processor communicatively coupled to the memory, the processor provided in the second housing, wherein the accommodation part includes a fixing member configured to mount the fastening part to the accommodation part, and a switch button installed at a lower end of the accommodation part, and wherein the instructions, when executed by the processor, cause the electronic device to perform a specified function, based on an on/off pattern signal of the switch button generated in response to the movement of the first housing due to the pressing input applied to the first housing.

### CROSS-REFERENCE TO RELATED APPLICATION(S)

This application is a continuation application, claiming priority under 35 U.S.C. § 365(c), of an International application No. PCT/KR2024/016262, filed on Oct. 24, 2024, which is based on and claims the benefit of a Korean patent application number 10-2023-0147800, filed on Oct. 31, 2023, in the Ministry of Intellectual Property (MOIP), and of a Korean patent application number 10-2024-0000530, filed on Jan. 2, 2024, in the Ministry of Intellectual Property (MOIP), the disclosure of each of which is incorporated by reference herein in its entirety.

### BACKGROUND

### 1. Field

The disclosure relates to a wearable electronic device and a method for controlling the same.

### 2. Description of Related Art

With technological advancements, electronic devices have become more compact for enhanced portability while evolving to perform diverse functions in various usage forms according to user needs. Wearable devices, which can be worn or attached directly to user's body parts, are one such form.

Recently, as wearable devices that attach directly to user's body parts have become widely used, there is a growing need to diversify their related functions and appearance.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable electronic device and a method for controlling the same.

Additional aspects will be set forth in part in the description which follows and, in part, will be apparent from the description, or may be learned by practice of the presented embodiments.

In accordance with an aspect of the disclosure, an electronic device is provided. The electronic device includes a first housing having a fastening part provided at a lower end thereof, a ring-shaped second housing having an accommodation part provided at an upper end thereof, the accommodation part configured to detachably accommodate the fastening part of the first housing to allow the first housing to move in response to a downward pressing input applied to the first housing, memory, including one or more storage media, storing instructions, and a processor communicatively coupled to the memory, the processor provided in the second housing, wherein the accommodation part includes a fixing member configured to mount the fastening part to the accommodation part, and a switch button installed at a lower end of the accommodation part, and wherein the instructions, when executed by the processor, cause the electronic device to perform a specified function, based on an on/off pattern signal of the switch button generated in response to the movement of the first housing due to the pressing input applied to the first housing.

In accordance with another aspect of the disclosure, an electronic device is provided. The electronic device includes a ring-shaped housing having an accommodation part provided at an upper end thereof, the accommodation part configured to detachably accommodate, in response to a downward pressing input applied to an external device having a fastening part, the fastening part of the external device to allow the external device to move, memory, including one or more storage media, storing instructions, and a processor communicatively coupled to the memory, the processor provided in the housing, wherein the accommodation part includes a fixing member configured to mount the fastening part to the accommodation part, and a switch button installed at a lower end of the accommodation part, and wherein the instructions, when executed by the processor, cause the electronic device to perform a specified function, based on an on/off pattern signal of the switch button generated in response to the movement of the external device due to the pressing input applied to the external device.

In accordance with another aspect of the disclosure, one or more non-transitory computer-readable storage media storing one or more computer programs including computer-executable instructions that, when executed by a processor of an electronic device individually or collectively, cause the electronic device to perform operations are provided. The operations include performing a specified function, based on an on/off pattern signal of a switch button of the electronic device, the on/off pattern signal generated in response to a movement of a housing of the electronic device due to a pressing input applied to the housing.

The technical problems, technical features, and effects to be achieved by the disclosure are not limited to those mentioned above, and other technical problems, technical features, and effects not mentioned herein will be clearly understood by those skilled in the art to which the disclosure pertains from the following description.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram of an electronic device according to an embodiment of the disclosure;

FIG. 3 is a block diagram of an electronic device according to an embodiment of the disclosure;

FIG. 4 is a cross-sectional view illustrating a structure of an electronic device according to an embodiment of the disclosure;

FIG. 5 is a cross-sectional view illustrating a portion of the structure of the electronic device in FIG. 4 in more detail according to an embodiment of the disclosure;

FIG. 6 is a cross-sectional view illustrating a structure of an electronic device according to an embodiment of the disclosure;

FIG. 7 is a cross-sectional view illustrating in more detail a portion of the structure of the electronic device in FIG. 6 according to an embodiment of the disclosure;

FIG. 8 is a cross-sectional view illustrating in more detail a portion of the structure of the electronic device in FIG. 5 according to an embodiment of the disclosure;

FIG. 9 is a drawing illustrating an example of an external device attachment method with respect to an electronic device according to an embodiment of the disclosure;

FIG. 10 is a drawing illustrating an example of an external device attachment method with respect to an electronic device according to an embodiment of the disclosure;

FIG. 11 is a flowchart illustrating the operation of an electronic device according to an embodiment of the disclosure; and

FIG. 12 is a flowchart illustrating the operation of an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

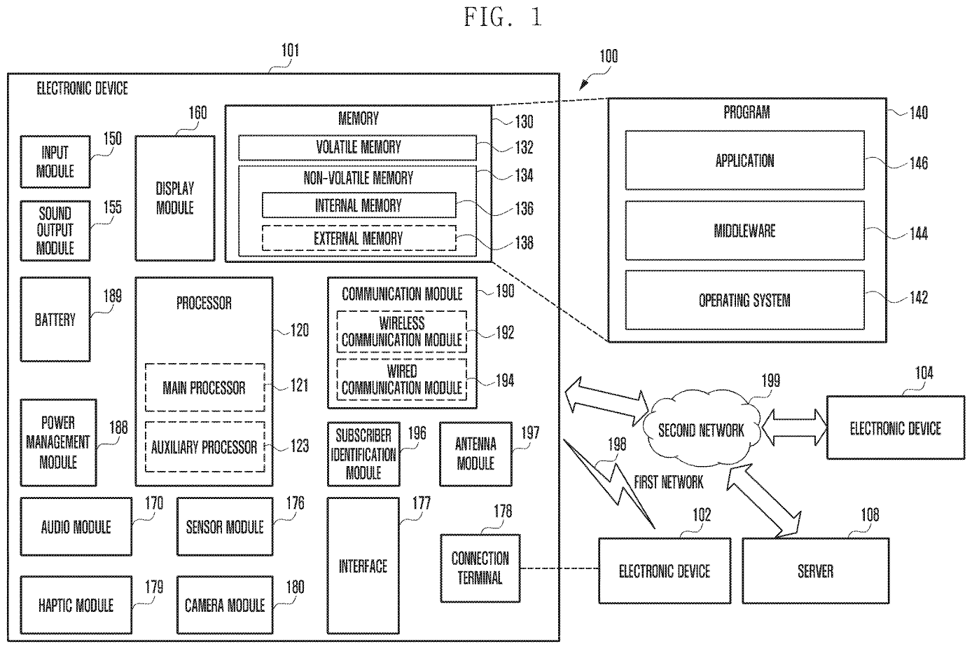

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

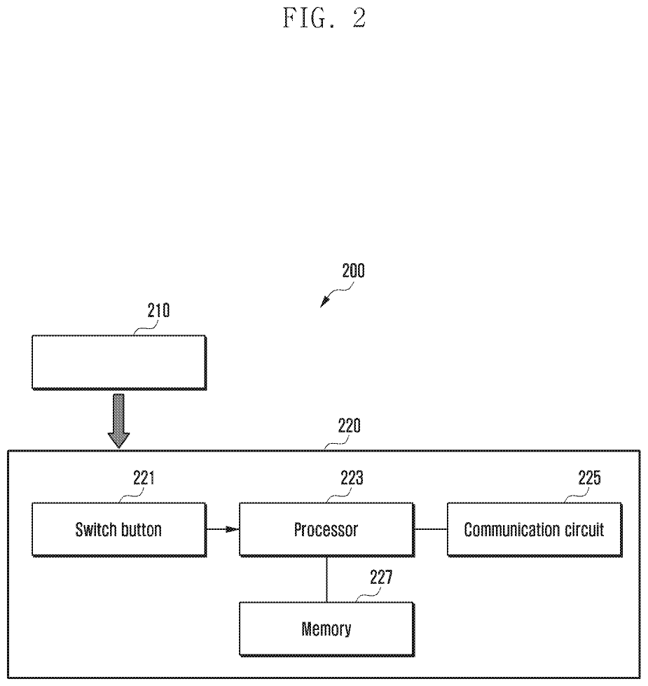

FIG. 2 is a block diagram of an electronic device according to an embodiment of the disclosure.

Referring to FIG. 2, an electronic device 200 (e.g., the electronic device 101 in FIG. 1) may include a finger-worn wearable device. However, the disclosure is not limited thereto, and various types of electronic devices, capable of obtaining a user's biometric information or motion information by incorporating various sensors, such as optical sensors (e.g., photoplethysmography (PPG) sensors) or motion sensors, may correspond to the electronic device 200 in the disclosure. For example, the electronic device 200 according to various embodiments may also be implemented as various wearable devices, such as body-attachable devices (e.g., health patches or digital tattoos), clothing-type devices (e.g., smart clothing or gloves), or band-type devices (e.g., wrist/arm/finger bands or smart rings).

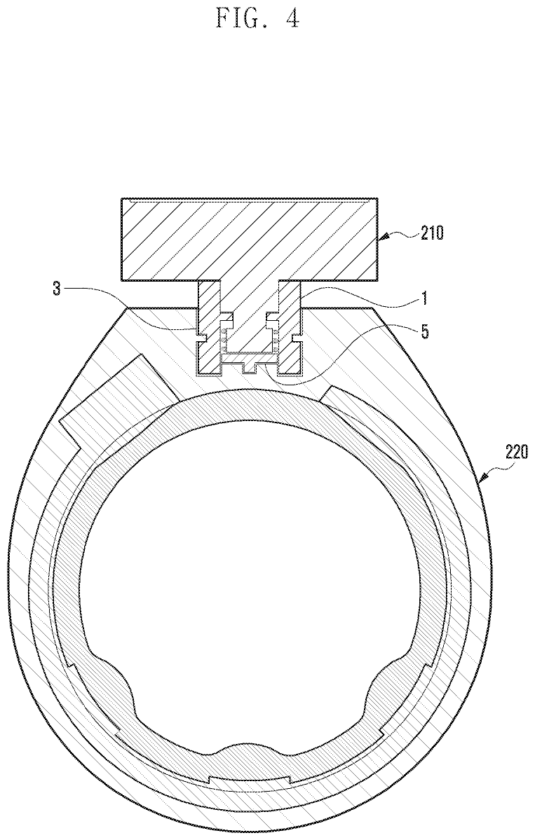

According to an embodiment, the electronic device 200 may include a first housing 210 and a second housing 220 that are connected in a detachable manner. The first housing 210 may be detachably fastened to the upper surface of the second housing 220 such that it is capable of moving relative to the second housing 220, in a fastened state with the second housing 220, in response to a pressing input (e.g., push pressure) in a specific direction (e.g., downward direction or opposing direction). The structure and attachment/detachment method of the first housing 210 and the second housing 220 will be described in detail later with reference to FIGS. 4 to 10. Although the electronic device 200 has been described as including both the first housing 210 and the second housing 220 herein, depending on the situation, the electronic device 200 may be configured and manufactured to include, for example, only the second housing 220, while the first housing 210 may be configured as a separate device.

The second housing 220 may be implemented in the form of a ring to wrap around at least a portion of the outer surface of a measurement target (e.g., a user's body part (e.g., a finger)) when worn, thereby preventing the electronic device 200 from detaching from the measurement target due to the movement of the measurement target.

According to an embodiment, the electronic device 200 may include a switch button 221, a processor 223, and a communication circuit 225 provided in the second housing 220.

According to an embodiment, the switch button 221 may be turned on and off as it moves relative to the second housing 220 in response to a pressing input in a specified direction while the first housing 210 is fastened to the second housing 220. The switch button 221 may generate an on/off pattern signal in response to being turned on and off and transmit it to the processor 223. For example, various pattern signals may be preconfigured, such as a pattern where the switch button 221 remains in the on state for a specified period of time (e.g., 2 seconds or more), a pattern where the switch button 221 briefly turns on once and then off, or a pattern where the switch button 221 briefly turns on and off twice in succession.

According to an embodiment, the electronic device 200 may further include a memory 227 (e.g., the volatile memory 132 in FIG. 1 and/or the non-volatile memory 134 in FIG. 1). The memory 227 may be electrically connected to the processor 223 and may store various instructions that may be executed by the processor 223. Such instructions may include control commands such as arithmetic and logical operations, data movement, and input/output that may be recognized by the control circuit, and may be defined on a framework stored in the memory 227. Furthermore, the memory 227 may store at least some of the programs 140 in FIG. 1. Moreover, the memory 227 may store information about preconfigured pattern signals and/or information about the functions of the specified electronic device 200 corresponding to the preconfigured pattern signals.

According to various embodiments, the processor 223 may perform operations or data processing related to the control and/or communication of respective components of the electronic device 200, and may include at least some of the configurations and/or functions of the processor 120 shown in FIG. 1. For example, the processor 223 may be electrically connected to the switch button 221, the communication circuit 225, and/or the memory 227, and may control these components and/or process computation and/or data related to the operation of these components.

According to an embodiment, the processor 223 may load instructions stored in the memory 227 and, based on the loaded instructions, control components of the electronic device 200 to perform operations for implementing various embodiments and/or process computation and/or data related to the operation of these components.

The processor 223 may receive an on/off pattern signal generated based on the on/off state of the switch button 221 and control the electronic device 200 to perform a specified operation corresponding to the received on/off pattern signal. For example, the processor 223 may transmit control signals to external electronic devices (e.g., the electronic device 102) (e.g., speakers or headphones) connected directly or wirelessly to the electronic device 200 in response to the on/off pattern signal. For example, the control signal may cause the external electronic device 102 to execute a specified function (e.g., camera operation, phone recording, mode switching such as “Do Not Disturb” or airplane mode, control of various peripheral device functions, or transmission of an emergency distress signal). For example, in response to a specified start pattern signal, the processor 223 may perform a standby operation to receive and process the on/off pattern signal of the switch button 221. Upon receiving the specified start pattern signal, the processor 223 of the second housing 220 may activate the input function via the first housing 210 to perform a standby operation, and then, based on the on/off pattern signal input thereafter, perform the function or operation control provided by the second housing 220. Upon receiving a specified end pattern signal while the input function of the first housing 210 is activated, the processor 223 of the second housing 220 may terminate the standby operation and deactivate the input function of the first housing 210. For example, the start pattern signal and/or end pattern signal may be predefined as an on/off pattern signal where the switch button 221 remains in the on state for a specified period of time (e.g., 2 seconds or longer).

According to various embodiments, the communication circuit 225 may include at least some of the configurations and/or functions of the communication module 190 shown in FIG. 1. For example, the communication circuit 225 may provide communication with various external electronic devices (e.g., the electronic device 101, 102, or 104 or the server 108 in FIG. 1) under the control of the processor 223. For example, the electronic device 200 may perform short-range wireless communication using the communication circuit 225. The electronic device 200 may communicate with at least one external electronic device 101, 102, 104, or 108, based on near-field communication (NFC), Bluetooth, Bluetooth low energy (BLE), Wi-Fi Direct, and/or ultra-wideband (UWB) communication. The processor 223, based on a pattern signal input via the switch button 221, may transmit a specified request signal to a specified external electronic device (e.g., the electronic device 101, 102, or 104 or the server 108 in FIG. 1) including the user's smartphone, for example, using the communication circuit 225, as a specified function.

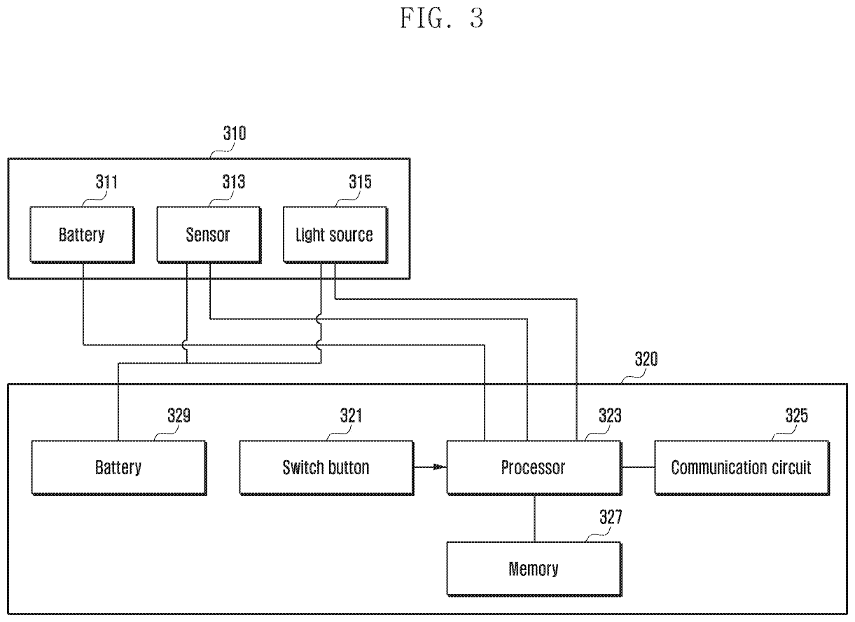

FIG. 3 is a block diagram of an electronic device according to an embodiment of the disclosure.

Referring to FIG. 3, the electronic device 320 (e.g., the electronic device 101 in FIG. 1) may include a finger-worn wearable device. However, the disclosure is not limited thereto, and various types of electronic devices capable of obtaining the user's biometric information or motion information by incorporating various sensors, such as optical sensors (e.g., PPG sensors) or motion sensors, may correspond to the electronic device 320 of the disclosure.

According to an embodiment, the electronic device 320 may be connected to the external device 310 in a detachable manner. The electronic device 320 may correspond to the second housing 220 in FIG. 2, and the external device 310 may correspond to the first housing 210 in FIG. 2. In the descriptions of the drawings described below, unless otherwise specified, the configuration of the electronic device 320 may include the configuration of the second housing 220. The external device 310 may be detachably attached to the upper surface of the electronic device 320 such that it is capable of moving relative to the electronic device 320, in a fastened state with the electronic device 320, in response to a pressing input in a specific direction. The appearance, structure, and attachment/detachment method of the electronic device 320 and the external device 310 will be described in detail later with reference to FIGS. 4 to 10.

According to an embodiment, the electronic device 320 may include a switch button 321, a processor 323, a communication circuit 325, a memory 327, and a battery 329.

According to an embodiment, the switch button 321 may be turned on and off as it moves relative to the electronic device 320 in response to a pressing input in a specified direction while the external device 310 is fastened to the electronic device 320. The switch button 321 may generate an on/off pattern signal in response to being turned on and off and transmit it to the processor 323. For example, various pattern signals may be preconfigured, such as a pattern where the switch button 321 remains in the on state for a specified period of time (e.g., 2 seconds or more), a pattern where the switch button 321 briefly turns on once and then off, or a pattern where the switch button 321 briefly turns on and off twice in succession.

According to an embodiment, the memory 327 may be electrically connected to the processor 323 and may store various instructions that may be executed by the processor 323. Furthermore, the memory 327 may store at least some of the programs 140 in FIG. 1. Moreover, the memory 327 may store information about preconfigured pattern signals and/or information about the functions of the electronic device 320 corresponding to the preconfigured pattern signals.

According to various embodiments, the processor 323 may perform operations or data processing related to the control and/or communication of respective components of the electronic device 320, and may include at least some of the configurations and/or functions of the processor 120 shown in FIG. 1. For example, the processor 323 may be electrically connected to the battery 329 to receive power, and may be electrically connected to the switch button 321, the communication circuit 325, and/or the memory 327 to control these components and/or process computation and/or data related to the operation of these components.

According to an embodiment, the processor 323 may load instructions stored in the memory 327 and, based on the loaded instructions, control components of the electronic device 320 to perform operations for implementing various embodiments and/or process computation and/or data related to the operation of these components.

The processor 323 may receive an on/off pattern signal generated based on the on/off state of the switch button 321 and control the electronic device 320 to perform a specified operation corresponding to the received on/off pattern signal. For example, the processor 323 may transmit control signals to external electronic devices (e.g., the electronic device 101 or 102) (e.g., speakers, headphones, or smartphones) connected directly or wirelessly to the electronic device 320 in response to the on/off pattern signal. For example, the control signal may cause the external electronic device to execute a specified function (e.g., camera operation, phone recording, mode switching such as “Do Not Disturb” or airplane mode, control of various peripheral device functions, or transmission of an emergency distress signal). For example, in response to a specified start pattern signal, the processor 323 may perform a standby operation to receive and process the on/off pattern signal of the switch button 321. Upon receiving the specified start pattern signal, the processor 323 disposed in the electronic device 320 may activate the input function via the external device 310 to perform a standby operation, and then, based on the on/off pattern signal input thereafter, perform the function or operation control provided by the electronic device 320. Upon receiving a specified end pattern signal while the input function of the external device 310 is activated, the processor 323 of the electronic device 320 may terminate the standby operation and deactivate the input function of the external device 310. For example, the start pattern signal and/or end pattern signal may be predefined as an on/off pattern signal where the switch button 321 remains in the on state for a specified period of time (e.g., 2 seconds or longer).

According to an embodiment, the communication circuit 325 may include at least some of the configurations and/or functions of the communication module 190 shown in FIG. 1. For example, the communication circuit 325 may provide communication with various external electronic devices (e.g., the electronic device 101, 102, or 104 or the server 108 in FIG. 1) under the control of the processor 323. For example, the electronic device 320 may perform short-range wireless communication using the communication circuit 325. The electronic device 320 may communicate with at least one external electronic device 101, 102, 104, or 108, based on near-field communication (NFC), Bluetooth, Bluetooth low energy (BLE), Wi-Fi Direct, and/or ultra-wideband (UWB) communication. The processor 323, based on a pattern signal input via the switch button 321, may transmit a specified request signal to a specified external electronic device (e.g., the electronic device 101, 102, or 104 or the server 108 in FIG. 1) including the user's smartphone, for example, using the communication circuit 325, as a specified function.

According to an embodiment, the external device 310 may include one or more of a battery 311, a sensor 313, or a light source 315.

The battery 311 may be charged via a solar panel provided on, for example, the external device 310 or wirelessly from an external power source. The battery 311 may supply power to the sensor 313 or the light source 315, or supply power to the electronic device 320 via an electric line connected to the electronic device 320. The sensor 313 may include various types of sensors capable of detecting the movement of the electronic device 320, such as a gyro sensor or an acceleration sensor. The light source 315 may employ digital lighting such as a light-emitting diode (LED) or electroluminescence (EL).

The sensor 313 or light source 315 may operate by receiving power from the battery 311 of the external device 310 or the battery 329 of the electronic device 320. The sensor 313 or light source 315 may be connected to the processor 323 of the electronic device 320 and operate under the control of the processor 323. The sensor 313 may obtain various sensor information and provide the obtained sensor information to the processor 323 of the electronic device 320.

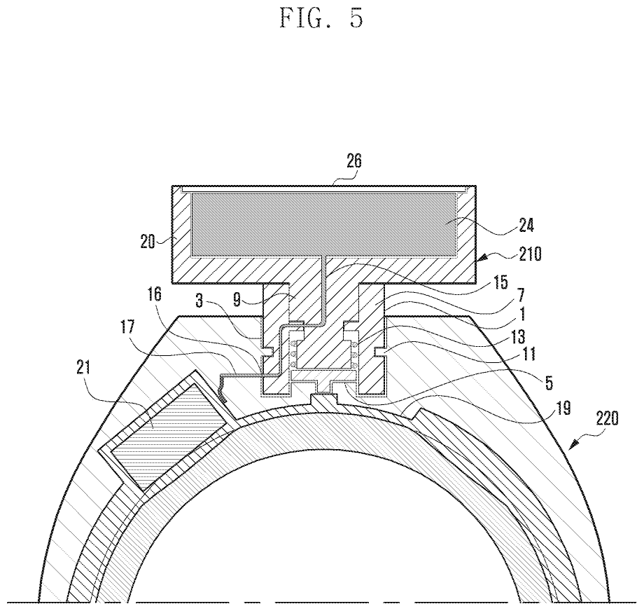

FIG. 4 is a cross-sectional view illustrating a structure of an electronic device (e.g., the electronic device 200 in FIG. 2 or the external device 310 and electronic device 320 in FIG. 3) according to an embodiment of the disclosure. FIG. 5 is a cross-sectional view illustrating a portion of the structure of the electronic device in FIG. 4 in more detail according to an embodiment of the disclosure.

Referring to FIGS. 4 and 5, the electronic device (e.g., the electronic device 200 in FIG. 2 or the electronic device 320 in FIG. 3) may be implemented in the form of a ring to wrap around at least a portion of the outer surface of a measurement target (e.g., a user's body part (e.g., a finger)) when worn, thereby preventing the electronic device from detaching from the measurement target due to the movement of the measurement target.

The electronic device may include a first housing 210 and a second housing 220 as shown in FIG. 2. The first housing 210 may correspond to the external device 310 in FIG. 3, and the second housing 220 may correspond to the electronic device 320 in FIG. 3. Hereinafter, although the first housing 210 and second housing 220 shown in FIG. 2 will be described by way of example, the description below may also be applied to the external device 310 and the electronic device 320 shown in FIG. 3.

The first housing 210 may be detachably fastened to the second housing 220. The first housing 210 may have a fastening part 1 at its lower end, and the second housing 220 may have an accommodation part 3 at its upper end, which is configured to accommodate the fastening part 1. The accommodation part 3 provided in the second housing 220 may accommodate the fastening part 1 of the first housing 210 and include a fixing member 11 configured to mount or secure the second housing 220.

The first housing 210 is movable, while being fastened to the second housing 220, in response to a pressing input (e.g., push pressure) in a direction toward the second housing 220 (e.g., in the downward direction or opposing direction). The second housing 220 may have a switch button 5 (e.g., the switch button 221 or 321 in FIG. 2 or 3) disposed at the lower end of the accommodation part 3, and as the first housing 210 moves according to the pressure input pattern applied to the first housing 210, the switch button 5 may be implemented to turn on and off, thereby generating an on/off pattern signal.

The fastening part 1 of the first housing 210 may include an external fastening part 7 that is tightly fitted and fastened to the accommodation part 3 of the second housing 220, and an internal fastening part 9 that passes through the external fastening part 7 to allow the first housing 210 to move. The external fastening part 7 may be fastened to the fixing member 11 provided in the accommodation part 3 when the fastening part 1 of the first housing 210 is accommodated in the accommodation part 3 of the second housing 220, thereby fastening the first housing 210 to the second housing 220. When the external fastening part 7 is accommodated in the accommodation part 3 and the first housing 210 is fastened to the second housing 220, a pressing input applied to the upper portion 20 of the first housing 210 causes the internal fastening part 9 to slide along the inner surface of the external fastening part 7, thereby moving the first housing 210 relative to the upper end of the second housing 220. As the internal fastening part 9 moves, the upper end of the switch button 5 of the second housing 220 may be pressed to turn on and off the switch button 5. The inner fastening part 9 may include an elastic member 13 at its lower end. As the first housing 210 is pressed, the internal fastening part 9 may move downward, thereby compressing the elastic member 13 to turn on the switch button 5. When the pressure on the first housing 210 is removed, the elastic member 13 may be stretched, thereby turning off the switch button 5.

The first housing 210 may be implemented to include one or more electrical structures 24 (e.g., a battery 311, a sensor 313, and/or a light source 315) in its upper portion 20. In the case where a battery 311 is disposed in the first housing 210, a solar panel 26 may be further provided to charge the battery 311.

The second housing 220 may include a flexible printed circuit board (FPCB) 19. The FPCB 19 may be formed in a curved shape to conform to the shape of the second housing 220. The second housing 220 may include a battery 21 (e.g., the battery 329 in FIG. 3), a processor (e.g., the processor 223 or 323 in FIG. 2 or 3), and/or a communication circuit (e.g., the communication circuit 225 or 325 in FIG. 2 or 3), which are mounted on the FPCB 19 and interconnected with each other. The processor may be connected to the switch button 5 via the FPCB 19 to receive an on/off pattern signal.

The first housing 210 may include an electric line or signal line 15. The second housing 220 may include an electric line or signal line 17. When the first housing 210 and the second housing 220 are fastened to each other, the electric line or signal line 15 of the first housing 210 may be connected to the electric line or signal line 17 of the second housing 220 at the contact point 16, thereby connecting one or more electrical structures 24 of the first housing 210 and the processor or battery 21 of the second housing to each other.

In the case where the first housing 210 includes a battery as one of the electrical structures 24, it may be implemented to charge power, for example, via a solar panel 26 and to supply power to electrical structures such as the processor in the second housing 220 via an interconnected electric line. In the case where the first housing 210 includes the sensor 313, it may be implemented to transmit generated sensor information to the processor of the second housing 220 via an interconnected signal line. In the case where the first housing 210 includes the light source 315, it may be configured to operate by receiving control signals from the processor of the second housing 220 via an interconnected signal line. The electrical structure 24 (e.g., the sensor 313 or the light source 315) of the first housing 210 may be implemented to receive power from the battery 21 of the second housing 220 via an interconnected electric line.

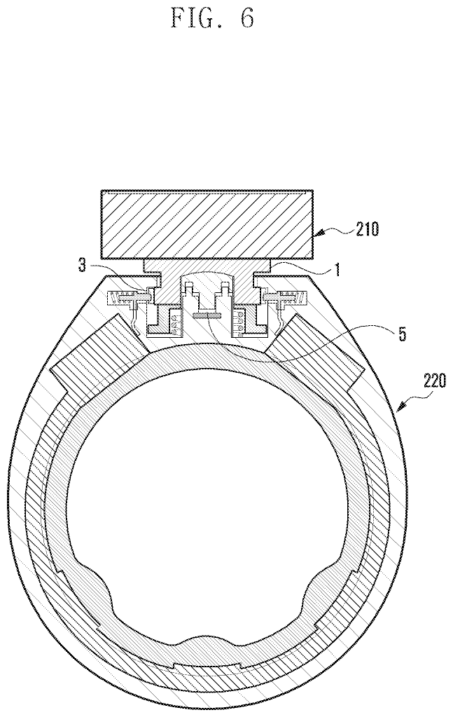

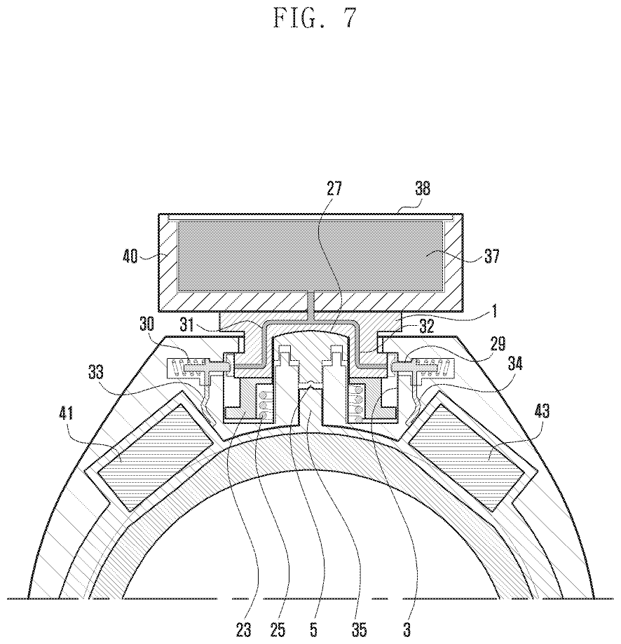

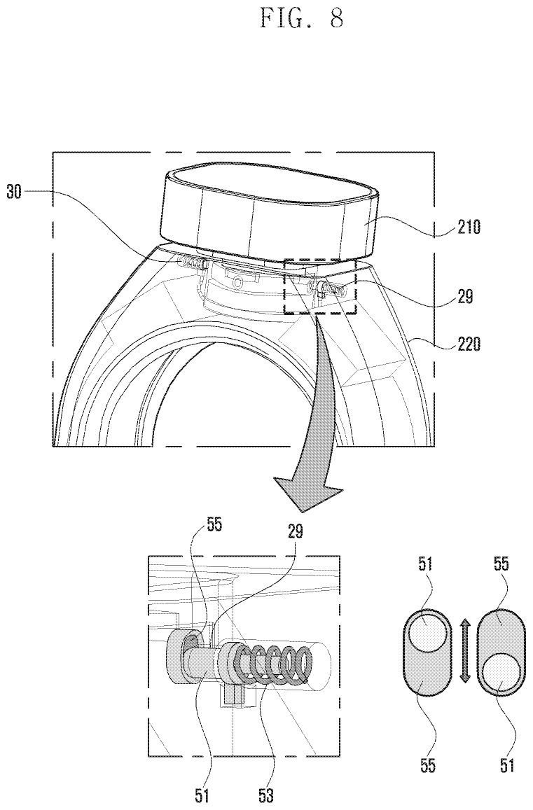

FIG. 6 is a cross-sectional view illustrating a structure of an electronic device according to an embodiment of the disclosure. FIG. 7 is a cross-sectional view illustrating in more detail a portion of the structure of the electronic device in FIG. 6 according to an embodiment of the disclosure. FIG. 8 is a cross-sectional view illustrating in more detail a portion of the structure of the electronic device in FIG. 6 according to an embodiment of the disclosure.

Referring to FIGS. 6 and 7, an electronic device (e.g., the electronic device 200 in FIG. 2 or the electronic device 320 in FIG. 3) may be implemented in the form of a ring to wrap around at least a portion of the outer surface of a measurement target (e.g., a user's body part (e.g., a finger)) when worn, thereby preventing the electronic device from detaching from the measurement target due to the movement of the measurement target.

The electronic device may include a first housing 210 and a second housing 220 as shown in FIG. 2. The first housing 210 may correspond to the external device 310 in FIG. 3, and the second housing 220 may correspond to the electronic device 320 in FIG. 3. Hereinafter, although the first housing 210 and second housing 220 shown in FIG. 2 will be described by way of example, the description below may also be applied to the external device 310 and the electronic device 320 shown in FIG. 3.

The first housing 210 may be detachably fastened to the second housing 220. The first housing 210 may have a fastening part 1 at its lower end, and the second housing 220 may have an accommodation part 3 at its upper end, which is configured to accommodate the fastening part 1. The accommodation part 3 provided in the second housing 220 may accommodate the fastening part 1 of the first housing 210 and include a fixing member 29 configured to mount or secure the second housing 220.

The first housing 210 is movable (e.g., movable up and down), while being fastened to the second housing 220, in response to a pressing input in a direction toward the second housing 220 (e.g., in the downward direction). The second housing 220 may have a switch button 5 (e.g., the switch button 221 or 321 in FIG. 2 or 3) disposed at the lower end of the accommodation part 3, and as the first housing 210 moves according to the pressure input pattern applied to the first housing 210, the switch button 5 may be implemented to turn on and off, thereby generating an on/off pattern signal.

The accommodation part 3 of the second housing 220 may include a first portion 27 including the switch button 5, for example, in the central region of the accommodation part 3. The accommodation part 3 may include a second portion 23 disposed in the peripheral region of the first portion 27.

In the state in which the first housing 210 is fastened to the second housing 220, the lower end of the fastening part 1 of the first housing 210 may be implemented to be in close contact with the upper end of the first portion 27 and the upper end of the second portion 23.

The second portion 23 of the accommodation part 3 may have an elastic member 25 provided in its lower portion. The elastic member 25 of the second portion 23 may be compressed in the downward direction of the second housing 220 due to the pressure applied to cause the fastening part 1 of the first housing 210 to be accommodated within the accommodation part 3 of the second housing 220, and the compression may cause the second portion 23 to descend, thereby forming an empty space, so that the fastening part 1 may be seated into the formed empty space. As the fastening part 1 is seated on the accommodation part 3, the fastening part 1 may be mounted to the accommodation part 3 by a fixing member (e.g., a pogo pin 29 and/or 30).

When the first housing 210 is pressed toward the second housing 220, the first portion 27 may move in response to the distance the first housing 210 moves, thereby generating an on/off pattern signal of the switch button 5.

The first housing 210 may be implemented to include one or more electrical structures 37 (e.g., a battery 311, a sensor 313, and/or a light source 315) in its upper portion 40. In the case where a battery 311 is disposed in the first housing 210, a solar panel 38 may be further provided to charge the battery 311.

The second housing 220 may include a flexible printed circuit board (FPCB) 35. The FPCB 35 may be formed in a curved shape to conform to the shape of the second housing 220. The second housing 220 may include a battery (e.g., the battery 329 in FIG. 3), a processor (e.g., the processor 223 or 323 in FIG. 2 or 3), and/or a communication circuit (e.g., the communication circuit 225 or 325 in FIG. 2 or 3), which are mounted on the FPCB 35 and interconnected with each other. The processor may be connected to the switch button 5 via the FPCB 35 to receive an on/off pattern signal.

The first housing 210 may include an electric line 31 and/or signal line 32 The second housing 220 may include an electric line 33 and/or signal line 34. When the first housing 210 and the second housing 220 are fastened to each other, the electric line 31 and/or signal line 32 of the first housing 210 may be connected to the electric line 33 and/or signal line 34 of the second housing 220 via a pogo pin 29 and/or 30, thereby interconnecting one or more electrical structures 37 of the first housing 210 and one or more electrical structures 41 or 43 (e.g., a processor or battery) of the second housing 220.

In the case where the first housing 210 includes a battery (e.g., the battery 329 in FIG. 3), it may be implemented to charge power, for example, via a solar panel 38 and to supply power to electrical structures such as the processor of the second housing 220 via an interconnected electric line. In the case where the first housing 210 includes the sensor 313, it may be implemented to transmit generated sensor information to the processor of the second housing 220 via an interconnected signal line. In the case where the first housing 210 includes the light source 315, it may be configured to operate by receiving control signals from the processor of the second housing 220 via an interconnected signal line. The electrical structure 37 (e.g., the sensor 313 or the light source 315) of the first housing 210 may be implemented to receive power from the battery 41 and/or 43 of the second housing 220 via an interconnected electric line.

FIG. 8 may illustrate a pogo pin connector structure according to an embodiment of the disclosure.

Referring to FIG. 8, the accommodation part 3 of the second housing 220 may include two or more pogo pins 29 and/or 30 protruding from its lateral surface toward the fastening part 1. The fastening part 1 may include two or more grooves 55 formed at positions corresponding to the two or more pogo pins 29 and/or 30. The two or more grooves 55 formed on the fastening part 1 may accommodate the two or more pogo pins 29 and/or 30 of the accommodation part 3, respectively, and interlock with each other, thereby enabling the fastening part 1 to be fastened to the accommodation part 3.

The two or more grooves 55 may allow the pogo pins 29 and/or 30 to move relative to the first housing 210 by a specified distance in response to a pressing input applied to the first housing 210. The two or more grooves 55 may be formed to be larger vertically than the cross-section of the head 51 of the two or more pogo pins 29 and/or 30 by the distance, thereby accommodating the two or more pogo pins 29 and/or 30 (head 51), respectively. The pogo pins 29 and/or 30 may include a spring structure 53 configured to be compressed and stretched in response to pressure for fastening or detaching the fastening part 1 of the first housing 210 to or from the accommodation part 3 of the second housing 220, allowing the head 51 to be mounted to or detached from the groove 55 so that the first housing 210 may be fastened to or detached from the second housing 220.

The heads 51 of the two or more pogo pins 29 and/or 30 and the two or more grooves 55 provided on the fastening part 1 may have electrical components applied to their mutually contacting surfaces, thereby enabling current or electrical signals to be transmitted via the mutually contacting surfaces as contact points. The two or more pogo pins 29 and/or 30 and the two or more grooves 55 provided on the fastening part 1 may be configured such that, even when the pogo pins 29 and/or 30 move while being accommodated in the grooves 55, the signal line 31 and/or electric line 32 connected to the pogo pins 29 and/or 30 inside the first housing 210 and the signal line 33 or electric line 34 connected to the two or more grooves 55 inside the second housing 220 may be continuously connected to each other.

In the state in which the first housing 210 and the second housing 220 are fastened to each other, the electric line 31 and/or signal line 32 of the first housing 210 are always connected to the electric line 33 and/or signal line 34 of the second housing 220 through the pogo pin 29 and/or 30 and the groove 55, thereby enabling constant connection between one or more electrical structures 37 of the first housing 210 and one or more electrical structures 41 or 43 (e.g., a processor or a battery) of the second housing 220.

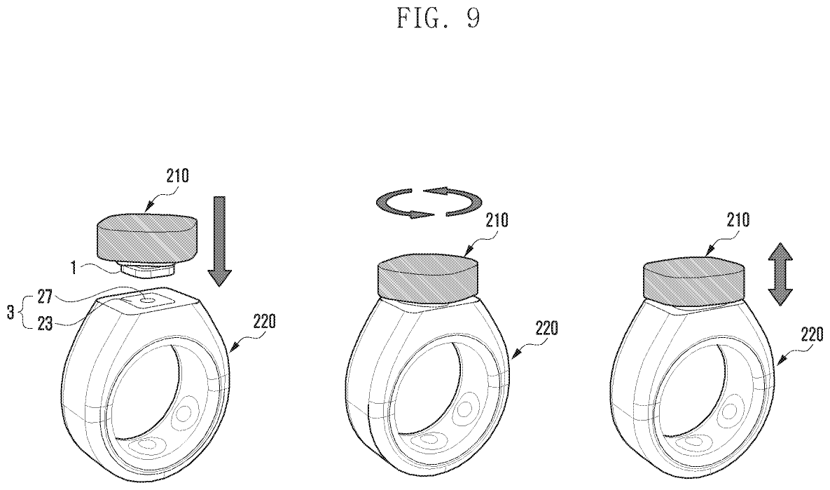

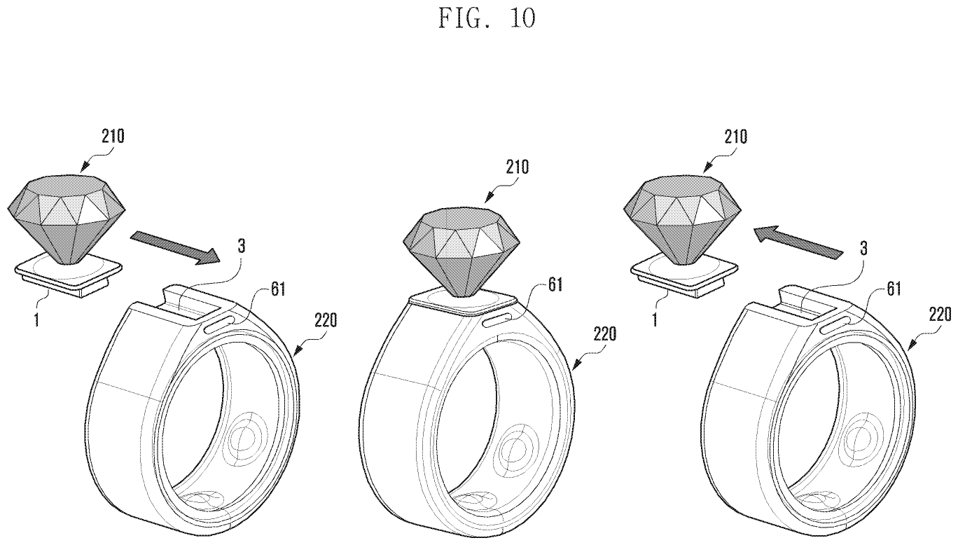

FIGS. 9 and 10 are drawings illustrating examples of external device attachment methods with respect to an electronic device according to various embodiments of the disclosure.

Referring to FIG. 9, an electronic device (e.g., the electronic device 200 in FIG. 2) may include a first housing 210 and a second housing 220. The first housing 210 may correspond to the external device 310 in FIG. 3, and the second housing 220 may correspond to the electronic device 320 in FIG. 3.

The first housing 210 may be detachably fastened to the second housing 220. The first housing 210 may be fastened to the second housing 220 by causing a fastening part (e.g., the fastening part 1 in FIGS. 4 to 7) provided at the lower end of the first housing 210 to be accommodated within an accommodation part 23 and 27 (e.g., the accommodation part 3 in FIGS. 4 to 7) provided at the upper end of the second housing 220.

As pressure is applied to the first housing 210 in a direction toward the upper end of the second housing 220, the second portion (e.g., the first portion 23 in FIG. 6 or FIG. 7) constituting the accommodation part 3 at the upper end of the second housing 220 may descend to form an empty space, and the fastening part 1 of the first housing 210 may be seated into the empty space formed.

The fastening part 1 of the first housing 210 may be engaged with the accommodation part 3 of the second housing 220 by rotating the fastening part 1 in a specified direction (approximately 45 degrees clockwise swivel) while the fastening part 1 is accommodated within the accommodation part 3 of the second housing 220.

The second portion 23 of the accommodation part 3 may have an elastic member 25 provided in its lower portion. The elastic member 25 of the second portion 23 may be compressed in the downward direction of the second housing 220 due to the pressure applied to cause the fastening part 1 of the first housing 210 to be accommodated within the accommodation part 3 of the second housing 220, and the compression may cause the second portion 23 to descend, thereby forming an empty space, so that the fastening part 1 may be seated into the empty space formed. After the fastening part 1 may be seated within the accommodation part 3 in response to a pushing operation, the first housing 210 and the second housing 220 may be fastened to each other by having a fixing member (e.g., the pogo pins 29 and/or 30 in FIG. 9) provided on the accommodation part 3 mounted into a groove (e.g., the groove 55 in FIG. 9) formed on the fastening part 1 in response to a swiveling operation.

While the first housing 210 is fastened to the second housing 220, two or more grooves 55 of the fastening part 1 may be released from the pogo pins 29 and/or 30 by an operation (approximately 45 degrees counterclockwise swivel) of twisting the first housing 210 in a direction opposite to the fastening operation. Subsequently, by lifting the first housing 210 upward or by removing pressure, the fastening part 1 of the first housing 210 may be separated from the accommodation part 3 of the second housing 220, thereby allowing the first housing 210 to be detached from the second housing 220.

The second portion 23 of the accommodation part 3 may be configured such that its upper end is raised upward through the stretching of the elastic member 25 provided beneath it, thereby forming a surface substantially coplanar with the upper end of the first portion 27.

When the first housing 210 is detached from the second housing 220, the first portion 27 may be raised such that the upper surfaces of the first portion 27 and the second portion 23 of the second housing 220 form a surface substantially coplanar with the upper surface of the second housing 220.

Referring to FIG. 10, an electronic device (e.g., the electronic device 200 in FIG. 2) may include a first housing 210 and a second housing 220. The first housing 210 may correspond to the external device 310 in FIG. 3, and the second housing 220 may correspond to the electronic device 320 in FIG. 3.

The first housing 210 may be detachably fastened to the second housing 220. The first housing 210 may be fastened to the second housing 220 by causing a fastening part (e.g., the fastening part 1 in FIGS. 4 to 7) provided at the lower end of the first housing 210 to be accommodated within an accommodation part 23 and 27 (e.g., the accommodation part 3 in FIGS. 4 to 7) provided at the upper end of the second housing 220.

By pushing the first housing 210 or sliding it a specified distance toward the second housing 220 from the side of the second housing 220, the fastening part 1 of the first housing 210 may be inserted into and seated within the accommodation part 3 at the upper end of the second housing 220.

The fastening part 1 of the first housing 210 may be secured to the accommodation part 3 of the second housing 220 through a sliding action of the fastening part 1 of the first housing 210 in a specified direction while being accommodated within the accommodation part 3 of the second housing 220.

The accommodation part 3 may include a fixing member (e.g., the pogo pin 29 and/or 30 in FIG. 9) formed to protrude from its lateral surface, as shown in FIGS. 4 to 8. In response to lateral pressure to accommodate the fastening part 1 of the first housing 210 into the accommodation part 3 of the second housing 220, the fastening part 1 may slide within the upper accommodation part 3 of the second housing 220, and for example, the pogo pin 29 and/or 30 may be mounted to a groove (e.g., the groove 55 in FIG. 9) formed on the fastening part 1 of the first housing 210, thereby fastening the first housing 210 and the second housing 220.

In the state in which the first housing 210 is fastened to the second housing 220, pressing a release button 61 provided on the second housing 220 may allow two or more grooves 55 of the fastening part 1 to be released from the pogo pins 29 and/or 30. Subsequently, by sliding the first housing 210 in a direction opposite to the fastening direction, the fastening part 1 of the first housing 210 may be separated from the accommodation part 3 of the second housing 220, thereby detaching the first housing 210 from the second housing 220.

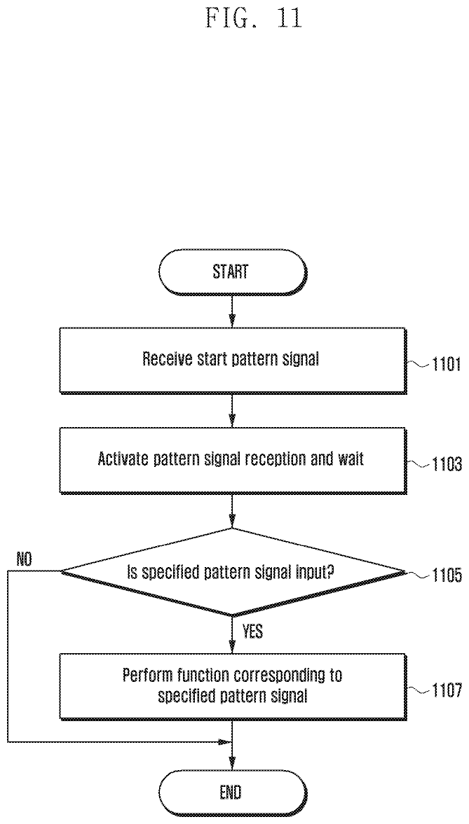

FIG. 11 is a flowchart illustrating the operation of an electronic device (e.g., the electronic device 200 or 320 in FIG. 2 or FIG. 3) according to an embodiment of the disclosure.

According to an embodiment, a processor (e.g., the processor 223 or 323 in FIG. 2 or FIG. 3) of the electronic device may receive an on/off pattern signal generated as a switch button (e.g., 321) of a second housing (e.g., the second housing 220 in FIG. 2) or an electronic device (e.g., the electronic device 320 in FIG. 3) is turned on or off in response to a press pattern input to a first housing (e.g., the first housing 210 in FIG. 2) or an external device (e.g., the external device 310 in FIG. 3), and control the electronic device to perform a specified operation corresponding to the received on/off pattern signal.

In operation 1101, the processor may receive a specified start pattern signal. The start pattern signal may include, for example, an on/off pattern signal where a switch button remains in the on state for a specified period of time (e.g., 2 seconds or longer).

In operation 1103, the processor may activate a pattern signal reception function from the switch button in response to receiving the specified start pattern signal and perform a standby operation to wait for reception of the pattern signal. For example, in response to the specified start pattern signal, the processor may enter a standby operation to receive and process the on/off pattern signal from the switch button. For example, in response to receiving the specified start pattern signal, the processor may activate an input function via the first housing or the external device.

In operation 1105, the processor may determine whether a specified on/off pattern signal is input from the switch button while performing the standby operation. The processor may activate an input function based on receiving the specified pattern signal to perform a standby operation, and control the operation according to a pattern signal input received during the standby operation, thereby preventing malfunctions caused by unintended pressure applied to the first housing or the external device.

In operation 1107, based on identifying the input of the specified pattern signal, the processor may control the electronic device to perform a specified function corresponding to the specified pattern signal. For example, the processor may perform function or operation control provided by the electronic device, based on subsequently input on/off pattern signals. For example, in response to a specified on/off pattern signal, the processor may transmit control signals to external electronic devices (e.g., the electronic devices 101, 102, 104, or 108) (e.g., smartphones, speakers, or headphones) connected directly or wirelessly to the electronic device. For example, the processor may request the external electronic device to perform a specified function (e.g., camera operation, phone recording, mode switching such as “Do Not Disturb” or airplane mode, control of various peripheral device functions, or transmission of an emergency distress signal) through a specified control signal corresponding to a specified on/off pattern signal.

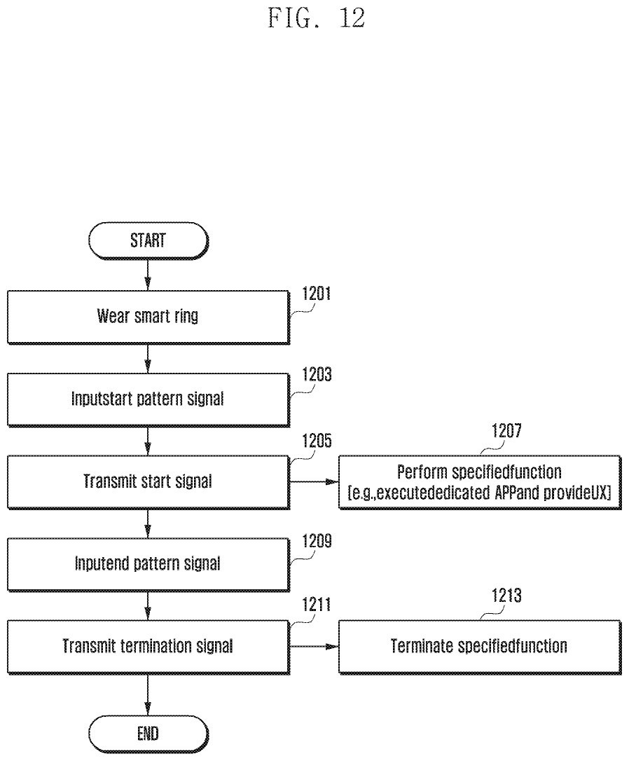

FIG. 12 is a flowchart illustrating the operation of an electronic device (e.g., the electronic device 200 or 320 in FIG. 2 or FIG. 3) according to an embodiment of the disclosure.

According to an embodiment, a processor (e.g., the processor 223 or 323 in FIG. 2 or FIG. 3) of the electronic device may receive an on/off pattern signal generated as a switch button (e.g., 321) is turned on or off in response to a press pattern input to a first housing (e.g., the first housing 210 in FIG. 2) or an external device (e.g., the external device 310 in FIG. 3), and transmit a request signal to an external electronic device to perform a specified function corresponding to a specified on/off pattern signal.

In operation 1201, the processor may identify that an electronic device (e.g., a smart ring) is worn on an object such as the user's finger. For example, the processor may identify that the smart ring is worn based on sensor information received from sensors provided in the electronic device, the first housing, or the external device.

In operation 1203, the processor may receive a specified start pattern signal while the smart ring is worn. The start pattern signal may include, for example, an on/off pattern signal where a switch button remains in the on state for a specified period of duration (e.g., 2 seconds or more).

In operation 1205, in response to receiving the specified start pattern signal, the processor may transmit a specified function start signal to a specified external electronic device (e.g., the electronic device 101, 102, 104, or 108) (e.g., a smartphone) connected directly or wirelessly to the electronic device. For example, the specified function start signal may include a control signal requesting the external electronic device to start a specified function. For example, the processor may transmit, to the external electronic device, a signal requesting the external electronic device to perform an operation, as the specified function, such as executing a dedicated application that provides a control function for the electronic device or providing a user interface (UI or UX) that provides a control function. In operation 1207, the external electronic device may perform a specified operation in response to receiving the start signal, such as executing a dedicated application that provides a control function for the electronic device or providing a user interface (UI or UX) that provides a control function. For example, the electronic device may be controlled via a dedicated application or user interface running on the external electronic device based on the input of a specified start pattern signal.

In operation 1209, the processor may identify that a specified end pattern signal is input from the switch button. For example, the end pattern signal may be preconfigured as an on/off pattern signal where the switch button remains in the on state for a specified period of time (e.g., 2 seconds or more).

In operation 1211, the processor may transmit, to the external electronic device, a signal requesting termination of the specified function in response to the input of the specified end pattern signal. In operation 1213, the external electronic device may terminate the specified function in response to the termination request signal received from the electronic device. For example, when an end pattern signal is received from the switch button while the electronic device is controlled via a dedicated application or user interface running on the external electronic device, the processor may transmit a termination signal for the specified function to the external electronic device in response to the input of the end pattern signal. For example, the external electronic device receiving the termination signal may terminate the dedicated application or cease providing the user interface.

According to various embodiments, an electronic device (e.g., the electronic device 101 and/or 200 in FIG. 1 or FIG. 2) may include a first housing 210 having a fastening part (e.g., the fastening part 1 in FIGS. 4 to 10) provided at a lower end thereof, a ring-shaped second housing 220 having an accommodation part (e.g., the accommodation part 3 in FIGS. 4 to 10) provided at an upper end thereof, the accommodation part configured to detachably accommodate the fastening part of the first housing to allow the first housing to move in response to a downward pressing input applied to the first housing, and a processor (e.g., the processor 120 or 223 in FIG. 1 or FIG. 2) provided in the second housing 220. The accommodation part may include a fixing member (e.g., the fixing member 11 in FIG. 4) configured to mount the fastening part to the accommodation part, and a switch button (e.g., the switch button 221 or 5 in FIG. 2 or FIG. 4) installed at a lower end of the accommodation part. The processor may cause the electronic device to perform a specified function, based on an on/off pattern signal of the switch button generated in response to the movement of the first housing due to the pressing input applied to the first housing.

According to various embodiments, the processor may perform, based on receiving a start pattern signal where the switch button remains in an on state for a specified period of time or longer, a standby operation to receive and process the on/off pattern signal of the switch button.

According to various embodiments, the processor may cause the electronic device to perform the specified function, based on an on/off pattern signal of the switch button received during the standby operation.

According to various embodiments, the electronic device may further include a communication circuit (e.g., the communication circuit 225 in FIG. 2) provided in the second housing 220, and the processor may transmit a specified function execution request signal to an external electronic device via the communication circuit, based on receiving a start pattern signal where the switch button remains in an on state for a specified period of time or longer.

According to various embodiments, the processor may transmit a signal requesting termination of the specified function to the external electronic device via the communication circuit, based on receiving an end pattern signal where the switch button remains in an on state for a specified period of time or longer while the specified function is being executed in the external electronic device.

According to various embodiments, the electronic device may further include one or more of a sensor, a battery, or a light source provided in the first housing, and as the fastening part is fastened to the accommodation part by the fixing member, a signal line or electric line between one or more of the sensor, the battery, or the light source provided in the first housing and the processor provided in the second housing 220 is connected through a close contact portion between the fastening part and the accommodation part.

According to various embodiments, the accommodation part may include two or more pogo pins protruding from a lateral surface as a spring structure, and the fastening part may include two or more grooves formed in a specified direction to be larger than a head cross-section of the pogo pin by a specified distance at which the pogo pin is movable relative to the first housing in response to the pressing input applied to the first housing, and accommodating the two or more pogo pins, respectively.

According to various embodiments, the pogo pin and the groove may be configured such that, even when the pogo pin moves while being accommodated in the grooves, a signal line or electric line connected to the pogo pins inside the first housing and a signal line or electric line connected to the grooves inside the second housing 220 remain connected to each other.

According to various embodiments, the accommodation part may include a first portion including the switch button, and a second portion configured to be compressed as the fastening part fastens the first housing to the second housing 220, thereby accommodating the fastening part of the first housing.

According to various embodiments, while the first housing is fastened to the second housing 220, an upper end of the first portion may be in close contact with a lower end of the first housing, and as the first portion moves in response to a distance at which the first housing moves due to a pressing input applied to the first housing toward the second housing 220, an on/off pattern signal of the switch button may be generated.

According to various embodiments, when the first housing is detached from the second housing, upper surfaces of the first portion and the second portion of the second housing 220 may be raised to form a surface substantially coplanar with an upper surface of the second housing 220.

According to various embodiments, the fastening part may include an elastic member configured to compress and stretch to allow the first housing to move in response to a pressing input to the first housing.

According to various embodiments, the accommodation part may include an elastic member configured to compress and stretch to allow the first housing to move in response to a pressing input to the first housing.

According to various embodiments, the fastening part may be accommodated in the accommodation part and secured to the locking step in response to a pushing input and a swivel operation for the first housing in a direction toward the upper end of the second housing 220, thereby fastening the first housing to the second housing 220.

According to various embodiments, the fastening part may be accommodated in the accommodation part in a sliding manner and secured to the locking step, thereby fastening the first housing to the second housing 220.

According to various embodiments, an electronic device (e.g., the electronic device 101 and/or 320 in FIG. 1 or FIG. 3) may include a ring-shaped housing having an accommodation part provided at an upper end thereof, the accommodation part configured to detachably accommodate, in response to a downward pressing input applied to an external device having a fastening part, the fastening part of the external device to allow the external device to move, and a processor provided in the housing, wherein the accommodation part may include a fixing member configured to mount the fastening part to the accommodation part, and a switch button installed at a lower end of the accommodation part. The processor may cause the electronic device to perform a specified function, based on an on/off pattern signal of the switch button generated in response to the movement of the external device due to the pressing input applied to the external device.

According to various embodiments, the processor may perform, based on receiving a start pattern signal where the switch button remains in an on state for a specified period of time or longer, a standby operation to receive and process the on/off pattern signal of the switch button.

According to various embodiments, the processor may cause the electronic device to perform the specified function, based on an on/off pattern signal of the switch button received during the standby operation.

According to various embodiments, the electronic device may further include a communication circuit provided in the housing, and the processor may transmit a specified function execution request signal to an external electronic device via the communication circuit, based on receiving a start pattern signal where the switch button remains in an on state for a specified period of time or longer.

According to various embodiments, the processor may transmit a signal requesting termination of the specified function to the external electronic device via the communication circuit, based on receiving an end pattern signal where the switch button remains in an on state for a specified period of time or longer while the specified function is being executed in the external electronic device. The electronic device according to various embodiments disclosed in this document may be a device of various forms. The electronic device may include, for example, a portable communication device (e.g., a smartphone), a computer device, a portable multimedia device, a portable medical device, a camera, a wearable device, or a home appliance. The electronic device according to the embodiment of this document is not limited to the above-described devices.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first housing having a fastening part provided at a lower end thereof;
a ring-shaped second housing having an accommodation part provided at an upper end thereof, the accommodation part configured to detachably accommodate the fastening part of the first housing to allow the first housing to move in response to a downward pressing input applied to the first housing;
memory, comprising one or more storage media, storing instructions; and
a processor communicatively coupled to the memory, the processor provided in the second housing,
wherein the accommodation part comprises:
a fixing member configured to mount the fastening part to the accommodation part; and
a switch button installed at a lower end of the accommodation part, and
wherein the instructions, when executed by the processor, cause the electronic device to perform a specified function, based on an on/off pattern signal of the switch button generated in response to the movement of the first housing due to the pressing input applied to the first housing.

2. The electronic device of claim 1, wherein the instructions, when executed by the processor, further cause the electronic device to perform, based on receiving a start pattern signal where the switch button remains in an on state for a specified period of time or longer, a standby operation to receive and process the on/off pattern signal of the switch button.

3. The electronic device of claim 2, wherein the instructions, when executed by the processor, further cause the electronic device to perform the specified function, based on an on/off pattern signal of the switch button received during the standby operation.

4. The electronic device of claim 2, further comprising:
a communication circuit provided in the second housing,
wherein the instructions, when executed by the processor, further cause the electronic device to transmit a specified function execution request signal to an external electronic device via the communication circuit, based on receiving a start pattern signal where the switch button remains in an on state for a specified period of time or longer.

5. The electronic device of claim 4, wherein the instructions, when executed by the processor, further cause the electronic device to transmit a signal requesting termination of the specified function to the external electronic device via the communication circuit, based on receiving an end pattern signal where the switch button remains in an on state for a specified period of time or longer while the specified function is being executed in the external electronic device.

6. The electronic device of claim 1, further comprising:
one or more of a sensor, a battery, or a light source provided in the first housing,
wherein, as the fastening part is fastened to the accommodation part by the fixing member, a signal line or electric line between one or more of the sensor, the battery, or the light source provided in the first housing and the processor provided in the second housing is connected through a close contact portion between the fastening part and the accommodation part.

7. The electronic device of claim 1,
wherein the accommodation part comprises two or more pogo pins protruding from a lateral surface as a spring structure, and
wherein the fastening part comprises:
two or more grooves formed in a specified direction to be larger than a head cross-section of a pogo pin of the two or more pogo pins by a specified distance at which the pogo pin is movable relative to the first housing in response to the pressing input applied to the first housing, and
accommodating the two or more pogo pins, respectively.

8. The electronic device of claim 7, wherein the pogo pin and the groove are configured such that, even when the pogo pin moves while being accommodated in the grooves, a signal line or electric line connected to the pogo pins inside the first housing and a signal line or electric line connected to the grooves inside the second housing remain connected to each other.

9. The electronic device of claim 1, wherein the accommodation part comprises:
a first portion comprising the switch button; and
a second portion configured to be compressed as the fastening part fastens the first housing to the second housing, thereby accommodating the fastening part of the first housing.

10. The electronic device of claim 9,
wherein, while the first housing is fastened to the second housing, an upper end of the first portion is in close contact with a lower end of the first housing, and
wherein as the first portion moves in response to a distance at which the first housing moves due to a pressing input applied to the first housing toward the second housing, an on/off pattern signal of the switch button is generated.

11. The electronic device of claim 9, wherein, when the first housing is detached from the second housing, upper surfaces of the first portion and the second portion of the second housing are raised to form a surface substantially coplanar with an upper surface of the second housing.

12. The electronic device of claim 1, wherein the fastening part comprises an elastic member configured to compress and stretch to allow the first housing to move in response to a pressing input to the first housing.

13. The electronic device of claim 1, wherein the accommodation part comprises an elastic member configured to compress and stretch to allow the first housing to move in response to a pressing input to the first housing.

14. The electronic device of claim 1, wherein the fastening part is accommodated in the accommodation part and secured to the fixing member in response to a push operation and a swivel operation for the first housing in a direction toward an upper end of the second housing, thereby fastening the first housing to the second housing.

15. An electronic device comprising:
a ring-shaped housing having an accommodation part provided at an upper end thereof, the accommodation part configured to detachably accommodate, in response to a downward pressing input applied to an external device having a fastening part, the fastening part of the external device to allow the external device to move;
memory, comprising one or more storage media, storing instructions; and
a processor communicatively coupled to the memory, the processor provided in the housing,
wherein the accommodation part comprises:
a fixing member configured to mount the fastening part to the accommodation part; and
a switch button installed at a lower end of the accommodation part, and
wherein the instructions, when executed by the processor, cause the electronic device to perform a specified function, based on an on/off pattern signal of the switch button generated in response to the movement of the external device due to the pressing input applied to the external device.

16. The electronic device of claim 15, wherein the instructions, when executed by the processor, further cause the electronic device to perform, based on receiving a start pattern signal where the switch button remains in an on state for a specified period of time or longer, a standby operation to receive and process the on/off pattern signal of the switch button.

17. The electronic device of claim 16, wherein the instructions, when executed by the processor, further cause the electronic device to perform the specified function, based on an on/off pattern signal of the switch button received during the standby operation.

18. The electronic device of claim 16, further comprising:
a communication circuit provided in the housing,
wherein the instructions, when executed by the processor, further cause the electronic device to transmit a specified function execution request signal to an external electronic device via the communication circuit, based on receiving a start pattern signal where the switch button remains in an on state for a specified period of time or longer.

19. One or more non-transitory computer-readable storage media storing one or more computer programs including computer-executable instructions that, when executed by a processor of an electronic device individually or collectively, cause the electronic device to perform operations, the operations comprising:
perform a specified function, based on an on/off pattern signal of a switch button of the electronic device, the on/off pattern signal generated in response to a movement of a housing of the electronic device due to a pressing input applied to the housing.

20. The one or more non-transitory computer-readable storage media of claim 19, the operations further comprising:
perform, based on receiving a start pattern signal where the switch button remains in an on state for a specified period of time or longer, a standby operation to receive and process the on/off pattern signal of the switch button.
